(19) United States
(12) Patent Application Publication
(10) Pub. No.: US 2020/0211002 A1
(43) Pub. Date: Jul. 2, 2020

(54) SYSTEM AND METHOD FOR AUTHORIZATION TOKEN GENERATION AND TRANSACTION VALIDATION

(71) Applicant: The Authoriti Network, Inc., Hawthorne, NY (US)

(72) Inventor: Louis A. Steinberg, Yorktown Heights, NY (US)

(73) Assignee: The Authoriti Network, Inc., Hawthorne, NY (US)

(21) Appl. No.: 16/647,280

(22) PCT Filed: Apr. 3, 2018
(86) PCT No.: PCT/US2018/025900

§ 371 Date: Mar. 13, 2020

Related U.S. Application Data
(60) Provisional application No. 62/561,286, filed on Sep. 21, 2017.

(51) Int. Cl. G06Q 20/38; G06Q 20/40; H04L 9/32; H04L 9/08; G06F 17/14

(52) U.S. Cl. CPC G06Q 20/3825; G06Q 20/38215; G06Q 20/40; H04L 9/3213; H04L 2209/56; H04L 9/3239; H04L 9/0825; G06F 17/14; G06Q 2220/00; H04L 9/3228

(57) ABSTRACT

A system, method, and apparatus are defined that increase data security by offering a frequently changing Authorization Token that includes user-modifiable criteria. Without validation of the Authorization Token, a personal identifier, such as a Social Security Number or account number, is not accepted as a means to transact business or release information. A single mechanism allows both authentication of the owner of a personal identifier and the owner's ability to specify whether and how its use is authorized.

### CROSS-REFERENCE TO RELATED APPLICATIONS

This application claims the benefit of and priority to, under 35 U.S.C. 119(e), U.S. Provisional Patent Application 62/561,286, entitled “Method for Protecting Identifiers from Unauthorized Use” and filed Sep. 21, 2017, the contents of which is hereby incorporated herein by reference in their entireties for all purposes.

### FIELD OF INVENTION

Embodiments of the present disclosure relate to apparatus, systems and methods for securing data or transactions by providing a limited authorization to use specified identifiers.

### BACKGROUND

Computerization, telephones, and the Internet have electronically connected consumers and account holders with a variety of products and services provided by merchants and service providers such as banks, financial institutions, governmental authorities, insurance companies and medical service providers. For example, banks provide account holders with electronic access to their bank accounts, to execute transactions such as trading stocks or moving money, governmental authorities and insurance companies allow for returns and claims to be filed, while financial institutions and medical service providers may allow access of certain confidential data by trusted third parties. Merchants may make goods available to consumers for electronic purchase.

A consumer or account holder may use one or more identifiers to access their account or to perform a purchase transaction. An identifier may comprise a bank account number, a credit card number, a medical patient number, or information corresponding to a government ID (e.g., Social Security Number (“SSN”)) or the like, which collectively may be known as “Personally Identifiable Information” or “PII”. An identifier may be used to assert an online identity, and is also commonly used as a “shared secret” to authenticate and authorize a transaction.

Over time, the need to share these identifiers with multiple parties eliminates their ability to remain secret. Some uses of identifiers, such as Social Security Numbers, rely on their being kept secret to prevent misuse, but these identifiers are often broadly shared. The continued and broad request for presenting such identifiers reduce, if not eliminate, the owner's ability to retain these identifiers as secret. Once known, any person can present them and their validity persists for an effectively unbounded period of time. Further, as data breaches become more commonplace, the likelihood increases that the secrecy of these identifiers is significantly reduced if not lost. The unlimited validity of the identifier in combination with a data breach creates a valuable environment for identity theft, in which a malicious actor impersonates another to do things like establish credit without the knowledge or consent of the victim (the person whose identifier was misused). Thus, theft of Personally Identifiable Information, through a cyber-attack or other means, further erodes the secrecy. Further the static nature of PII can lead to unauthorized reuse as its value persists indefinitely.

In spite of the existing and increasing risks, it is still common for merchants and service provider computer systems to base purchases and other transactions on PII information. Users are asked to keep their PII a secret, and to use their PII to both authenticate and authorize their identity to access an electronic account or complete a transaction.

Thus, the use of personally identifiable information as both identifiers and authenticators by current technology is insufficient to ensure the validity of transactions. Current systems lack the technological structure and configuration to implement electronic account and transaction security that authenticates and authorizes the use of identifiers for transactions. While some service providers and financial institutions have implemented dual-factor authentication systems that use Short Message Service (“SMS”) or emailed authorization codes to increase security, these systems require a central server to generate tokens and communicate those tokens to the user's computer system, which is subject to interception and/or redirection during transmission to the user. In addition, these dual-factor systems may include centralized stores of valid tokens, which are vulnerable to compromise through hacking or other means, allowing access to potentially usable tokens. Further, existing systems generate and push Personal Identification Numbers (“PINs”) or tokens to the users that do not include any embedded information which is used to limit the use or validation of the tokens.

The recited embodiments address an inherently technological problem which increases with remote electronic transactions. When transactions are performed locally and manually and the purchaser or service user interacts directly with the merchant or service provider, the merchant or service provider has an opportunity to verify the identity of the consumer, but often is not sufficiently skilled to detect fraudulent identification.

The worldwide reach of the Internet allows consumers to electronically purchase goods or services or perform transactions, including permitting access to secure data, from anywhere in the world, which eliminates the personal interactions that may traditionally be used to assess the validity of transactions. Further, the electronic communication of purchase or transaction data gives rise to security issues with electronic transactions not present with manual transactions. As noted, data breaches on the Internet and data breaches of corporate servers have been commonplace, with such breaches exposing consumer identifiers such as credit card numbers, account numbers, and social security numbers. In addition, in systems which use tokens generated by a remote computer system, the remote computer system must send the token to the user to be sent back to the remote computer system. Transmissions from the remote computer system to the user are potentially insecure as they are subject to interception and/or redirection.

A technological configuration for providing secure transactions that does not rely on the security or secrecy of PII data, and which uses efficient data structures, is desired. In addition, a technological configuration that provides for local generation of a token, for example, on a user's mobile device, that describes the user's intent regarding the transaction, without requiring communication with a central server computer system which generates tokens, is desired.

### SUMMARY

Embodiments of the disclosure teach a device, system and method that implements an authenticated validation code mechanism (using Authorization Tokens) that also acts as limited authorization to use a specific identifier. Validation is not based solely on identifiers, so the identifiers no longer need to be kept secret, as they have no value without the ability to use them (i.e., by providing authorization) in each instance. This effectively separates identity assertion (the identifier) from authentication (validation of the assertion) and authorization (permission to use the identifier at a given time). Thus, while the disclosed embodiments use PII data for identification, the PII data neither provides authentication nor authorization for a transaction. Therefore, in the system and method of transaction security implemented by the proposed embodiments, there is no benefit to attempt to maintain the PII as a secret. The methods, apparatus and systems defined herein substantially reduce the value of the common identifiers that are not effectively kept secret today.

Embodiments of the disclosure define systems, devices and methods that enable a user to generate and provide an Authorization Token required to authorize and thereby enable transactions. The Authorization Token provides beneficial authentication and authorization for such transactions. Transactions which could be secured using an Authorization Token include, but are not limited to, opening an online account, transferring funds, accessing information, delegating and restricting information access to trusted 3^{rd} parties, or using a credit/debit card.

In one embodiment, a user enrolls to generate Authorization Tokens for use with their transactions. Enrollment may require a user to define a password that is utilized to generate a private/public key pair for use in a Private Key Infrastructure (“PKI”) system. In other embodiments, the system and method may be configured to pre-enroll users that have an existing relationship with a trusted third-party using a bulk enrollment process.

Enrolled users authenticate through a set of typical mechanisms such as, but not limited to a secret password or using a mobile device's biometric sensors to unlock a key chain that provides the password. In addition, the authentication password or secret is used to create a public/private key pair.

Once authenticated, the private key is used to digitally encrypt tokens authorizing limited use of the identifier (i.e., “Authorization Token”). The Authorization Tokens have within them a combination (through separate fields and/or by mathematically combining) both a (potentially hashed or otherwise derived) version of the original identifier and the user identified/selected limits on authorization of a transaction using said Identifier or PII.

Thus, once a user is enrolled (defined below), authentication and authorization are achieved by securely logging into a system comprised of software and/or hardware, potentially running on a web server, mobile device or other computing device, including devices deployed as part of the internet-of-things ecosystem. An embodiment of the disclosure utilizes a self-contained system, such as a mobile device or other user device, for authentication and to generate Authorization Tokens thereby removing the requirement to connect to a server-based system under the control of a third-party or an external server. The placement of the Authorization Token generation application on a self-contained device such as a mobile device or other user device provides for an unconventional arrangement in which the Authorization Token may be generated without connecting to a server-based system under the control of a third-party or an external server. Further, the combination of steps to locally generate the Authorization Token using a mobile device and without connectivity to any remote server-based computer systems comprises unconventional steps that are not routine or well-known, as token-based systems usually require access to or by remote server-based computer systems for token generation. In addition, the combination of steps to define the Authorization Token using efficient data structures and containing information impacting the use of the Authorization Token is also unconventional, and is not routine or well-known, and provides for technological advantages over prior art systems.

In an embodiment, a system for electronically authorizing transactions is disclosed. The system comprises a user computing device including an Authorization Token generator application (“generator application”). The generator application, in one embodiment, is configured to receive a password from a user and authenticate access of the user to the generator application. After the user's access is authenticated, the generator application is configured to receive at least one identifier to authorize, receive user-selected constraints for limiting the use of the identifier, combine the identifier and the user-selected constraints to create a unique token, and encrypt the unique token using a stored private key. The generator application is then configured to provide the Authorization Token to the user, wherein the Authorization Token is submitted, along with one or more pieces of Companion Transmitted Information to a transaction processor computing device to perform a transaction. The transaction processor computer system is configured to access a validator computer system to authenticate and validate the Companion Transmitted Information and the Authorization Token prior to permitting execution of the transaction using the Companion Transmitted Information.

In another embodiment, a method for generating an Authorization Token on a user computing device for authorizing transactions is disclosed. The method comprises receiving, by the Authorization Token generator application, an identifier to authorize, receiving, by the Authorization Token generator application, user-selected constraints, combining, by the Authorization Token generator application, the identifier and the user-selected constraints to create a unique token, and encrypting, by the Authorization Token generator application, the unique token using a stored private key to locally generate an Authorization Token by the Authorization Token generator application on the user computing device, wherein the Authorization Token is submitted, along with one or more pieces of Companion Transmitted Information to authorize the transaction when validated by a validator computer system.

In an embodiment, a mobile device comprises a data storage device storing program instructions for an Authorization Token generator application, and a computer processor configured to execute the program instruction for the Authorization Token generator application to locally generate an Authorization Token on the mobile device without interaction with a remote computer system. The Authorization Token generator application is configured to receive an identifier to authorize for a transaction, receive user-selected constraints for limiting the use of the identifier, combine the identifier and the user-selected constraints to create a unique token, and encrypt the unique token using a private key to generate an Authorization Token. The Authorization Token is provided to the mobile device, wherein the Authorization Token is configured to authorize the performance of the transaction when validated by a validator computer system.

### BRIEF DESCRIPTION OF THE DRAWINGS

Aspects of the present disclosure are illustrated by and are not limited by the accompanying drawings.

FIG. 1 is a block diagram illustrating the functional components of the system in accordance with an embodiment of the disclosure.

FIG. 2 is a block diagram illustrating the components and data flows of enrollment in accordance with an embodiment of the disclosure.

FIG. 2a depicts an exemplary process 220 for a user to enroll in the Authorization Token system.

FIG. 3 is a block diagram illustrating the components and data flows of an alternative embodiment for enrollment in accordance with an aspect of the disclosure.

FIG. 4 is a block diagram illustrating the components and data flows of an embodiment for generating the Authorization Token in accordance with an aspect of the disclosure.

FIGS. 5a1 and 5a2 define two embodiments for the structure of the Authorization Token in accordance with an aspect of the disclosure.

FIG. 5b defines one embodiment of the user-initiated constraints selected for the Authorization Token in accordance with an aspect of the disclosure.

FIG. 5c defines an alternate embodiment of the user-initiated constraints selected for the Authorization Token in accordance with an aspect of the disclosure.

FIG. 6 is a block diagram illustrating the components and data flows of an embodiment for validating generating the Authorization Token in accordance with an aspect of the disclosure.

FIG. 7 is a block diagram illustrating the components and data flows of an embodiment for validating an Authorization Token in accordance with an aspect of the disclosure.

FIG. 8 depicts a block diagram of a mobile device which may implement the Authorization Token generator computer system for generating Authorization Tokens in accordance with an aspect of the disclosure.

FIGS. 9, 9a and 9b define alternate embodiments of high-level system block diagrams (900) depicting exemplary device configurations of the system.

### DETAILED DESCRIPTION

Disclosed herein are processor-executable methods, computing systems, and related processing useful for implementing electronic security for identifier data using an Authorization Token. The Authorization Token provides permission to use an identifier such as a credit card number, social security number (“SSN”), account number, login username, email address, etc. in a limited manner. Also described is a system similarly involving one or more computers using software or hardware to electronically authorize said tokens (such as, but not limited to, opening an account, establishing credit, using credit, transferring funds, sharing information with 3^{rd} parties, permitting access to a controlled or secured platform).

As used herein, the term “processor” broadly refers to and is not limited to a single- or multi-core general purpose processor, a special purpose processor, a processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used herein, the terms “transaction” and “electronic transaction” broadly refer to any transaction which may be electronically validated using the Authorization Token generated by the recited system, method, and apparatus. A transaction may be deemed an “electronic transaction” if a token is electronically generated for the transaction, and the token is validated electronically, even if other aspects of the transaction are manually performed. For example, an Authorization Token which comprises a string of numbers may be electronically generated for a transaction which provides a user with telephonic access to financial records. The user may call a phone number to access the financial records, and may be prompted to input, into the telephone keypad, the string of numbers that represent the Authorization Token. The phone system receives the numbers and validates the token, then grants the user telephonic access to the financial records. Such a transaction is within the scope of “transactions” or “electronic transactions” encompassed by the embodiments, even though input of the Authorization Token is performed manually on a telephone keypad. Transactions include granting access, by a user or trusted third-party, to a physical device, including, but not limited to, a server or a building.

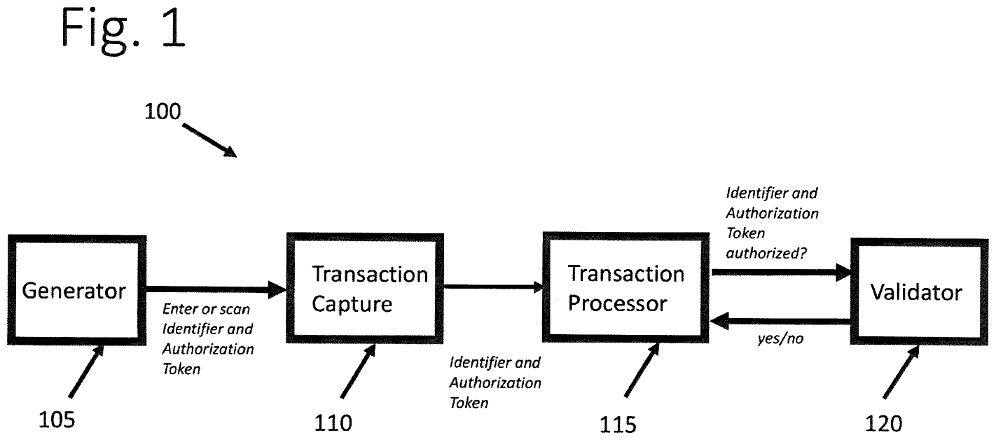

FIG. 1 is a high-level function block diagram (100) defining an embodiment of the functional elements of the disclosure. Specifically, this embodiment separates the user, the generator (105) of an Authorization Token, the transaction capture system (110) (such as a web site or bar code scanner), the transaction processor system (115), and the validator (120). Although the role of these elements is clearly distinct; the overall functionality of the system defined in one embodiment is built on the separation of functions and the interaction and interoperability of devices which perform the functions. In a separate embodiment, the generator may co-reside with the validator in a single hardware device that includes logically distinct functional elements.

The role of generator (105) is to authenticate the user, accept input regarding the Identifier (or “ID”) and constraints regarding the authorized use of said Identifier, and create an Authorization Token which securely combines the Identifier and constraints. In an embodiment, the generator (105) may comprise an Authorization Token generator computer system which includes a software application which resides on the system, which is accessible by a user's remote computer system. In one or more embodiments, the generator (105) may comprise a software application on a mobile device such as a tablet, smartphone, or a smart watch. The computer server, computer, or mobile device on which the generator resides may include a memory for storing the application, a processor for running the application, and a display for displaying a graphical user interface for accessing and performing functions with the application. In an embodiment in which the generator is an application resident on a mobile device, the mobile device may include a biometric sensor for receiving fingerprint or facial data, which may be used to unlock the password or private key on the device's key chain. Alternatively or additionally, the mobile device may include a keypad (virtual or real) for inputting a password, and/or the system may include a touchscreen for receiving a pattern that the user defines as their password. Although known methodologies for entering a password have been described, future alternatives for entering a password if deployed with the system, methods, and apparatus described herein do not limit the defined disclosures. The placement of the token generation application on a self-contained device such as a mobile device or other user device provides for an unconventional arrangement in which the Authorization Token may be generated without connecting to a server-based system under the control of a third-party or an external server.

Authorization Tokens are cryptographically signed strings that may contain letters, numbers, and other characters to authenticate a user, verify the user's association with an identifier such as an account or SSN, and indicate a limited authorization to make use of the identifier in one or more transactions. The Authorization Tokens may also take other forms. For example, an Authorization Token may be represented by a bar code or a QR code. Embedding user-selected limitations or constraints (in embodiments, at least one user-selected constraint) of a transaction along with one or more identifiers (in embodiments, at least one user identifier) within an Authorization Token provides an unconventional Authorization Token that is generated on a self-contained device by the user.

The role of transaction capture computer system (110) is to provide an entry point for the Authorization Token and other such information as is necessary to request the transaction. The transaction capture computer system (110) may comprise a remote computer system which a user may access via the Internet or other network, through their user computer system. Alternatively, it is within the scope of this disclosure to configure an architecture wherein generator (105) and transaction capture computer system (110) are separate and distinct functional routines executed within the same computer system that pass the Authorization Token between them. The network used for communication among devices and systems described herein can be virtually any form or mixture of networks consistent with embodiments as described herein include, but are not limited to, telecommunication or telephone lines, the Internet, an intranet, a local area network (LAN), a wide area network (WAN), virtual private network (VPN) and/or a wireless connection using radio frequency (RF) and/or infrared (IR) transmission to name a few. In an embodiment in which the Authorization Token is used for the transaction, including but not limited to a purchase, banking, brokerage or other type of transaction, the transaction capture system may generate interfaces for receiving the Authorization Token from the user. For example, the interface generated by the transaction capture system may include a field for receiving characters representing the Authorization Token. The interface may alternatively or additionally include options for receiving an Authorization Token which comprises a bar code or a QR code.

In another embodiment, the transaction capture system may comprise a point-of-sale device which is used to pay for items that a user wishes to purchase at a merchant's store. A point-of-sale device may include a keypad with a screen for guiding the purchaser through the purchase process. The screen may include a field for receiving characters representing the Authorization Token. Additionally, the point-of-sale device may further include other options for receiving an Authorization Token; for example, most point-of-sale devices include a scanner for reading bar codes, which could be used to read a bar code which represents the Authorization Token, such as a bar code displayed on the screen of the user's mobile device.

In an embodiment in which the transaction comprises a service such as providing a third-party with authorization to have limited access to at least a portion of the data in an account (such as a bank account, governmental authority, or medical provider account), the transaction capture system may comprise the service provider computer system (e.g., the bank computer system or the medical provider office computer system), which is configured to provide interfaces for receiving the user's identifier and Authorization Token from the third-party.

The role of transaction processor (115) is to request validation that the transaction is authorized and, if so, to proceed with the transaction. When the transaction comprises the purchase of an item using a credit or debit card, the transaction processor may comprise a payment card transaction server computer, which receives transaction data and the Authorization Token from a merchant computer system or point-of-sale device. When the transaction comprises gaining access, such as by a third-party, to an account such as a bank account or medical records or the like, the transaction processor may comprise the service provider's computer system such as a bank computer system or a medical provider computer system. That is, the service provider computer system may act as both the transaction capture system for receiving the transaction, and as the transaction processor for obtaining validation of the transaction. In such a situation, the transaction processor may also be responsible for authenticating the third-party and to capture the third-party's request for access to specific data or types of data in a specific account. Alternatively, the service provider may also employ a separate transaction processor for obtaining validation. The transaction processor may communicate with the transaction capture computer system and the validator via a network, such as the Internet.

The role of validator (120) is to process the Authorization Token provided to the transaction processor, to test the validity of the token and to determine whether the user-selected constraints have been met and satisfied, and return a response to the transaction processor system. Responsive to passing of the validity test, the validator may generate and transmit, to the transaction processor, a message indicating the validity of the Authorization Token. The validator may comprise a computer system having a processor, memory, and communications capability, which is configured (e.g., with software) to perform the validation of the Authorization Token.

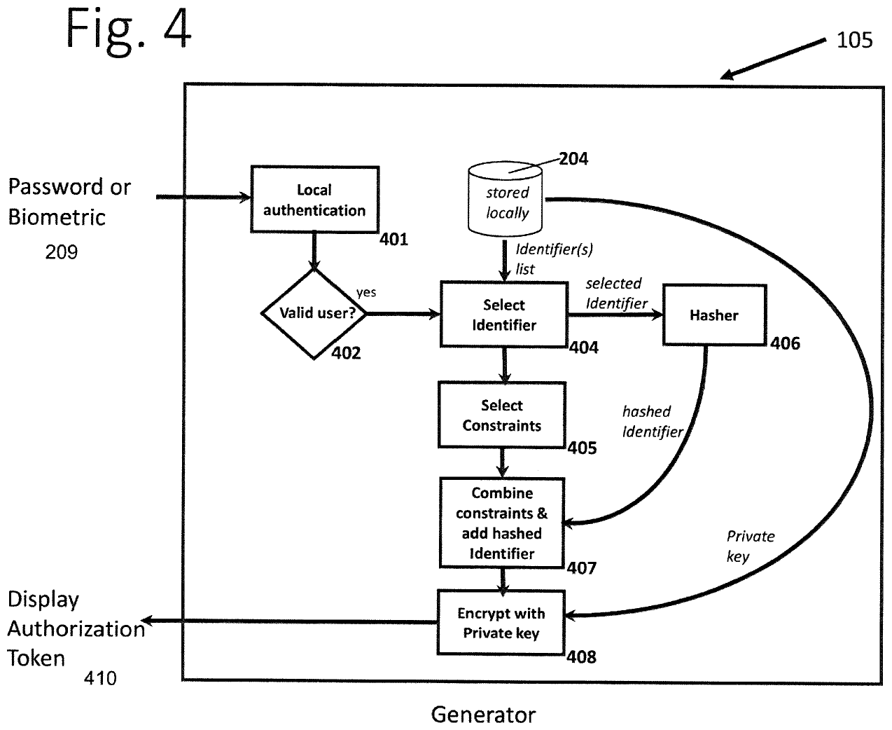

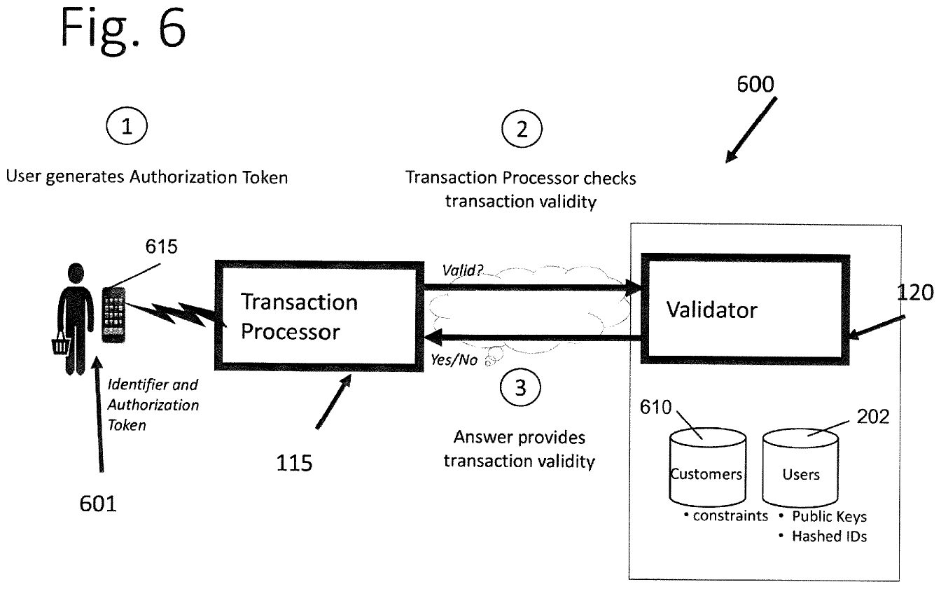

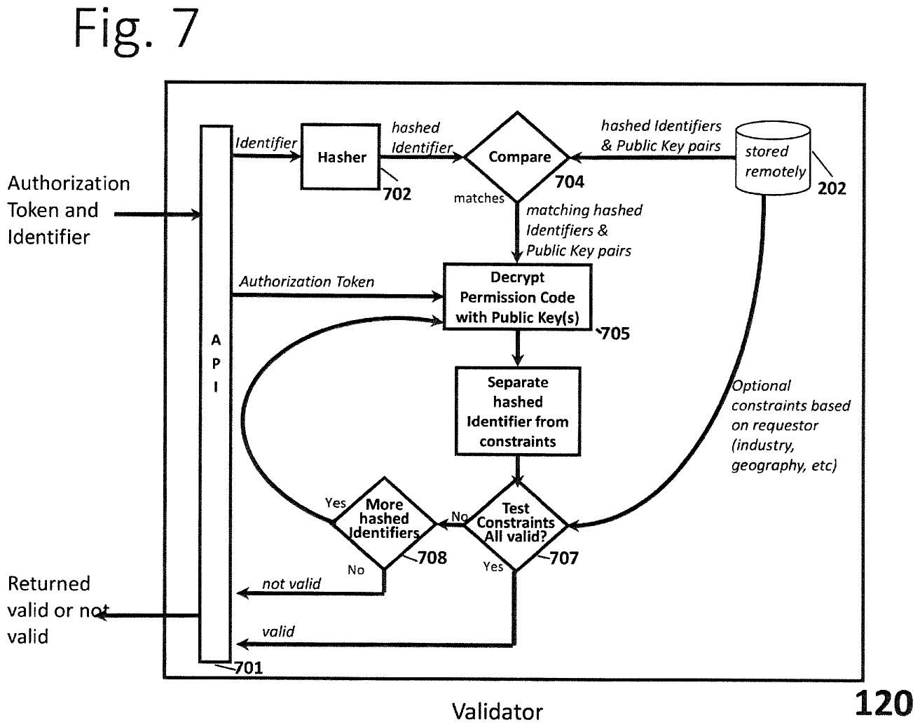

Implementation of the recited system, method, and device includes three primary computer-based functions for generating Authorization Tokens for electronically securing transactions: user enrollment (200), Authorization Token generation (FIG. 4), and Authorization Token validation (FIGS. 6 and 7). These three functions are implemented in hardware by software configured to perform the recited functions. In embodiments, the functions could also be implemented by firmware.

Definitions and permitted values of constraints may be accessible to both generators and validators, such as by storing locally such consistent definitions and values in suitable tables, databases, or otherwise, by both generators and validators, to provide for consistency in definitions and values of constraints inserted into tokens by generators and in definitions and values of constraints employed by validators in testing validity of tokens.

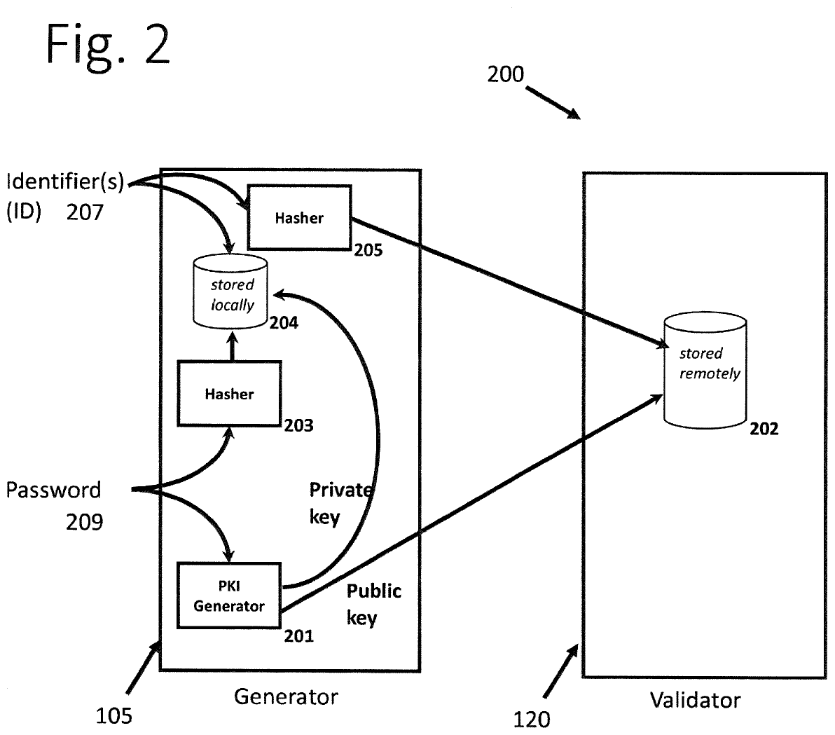

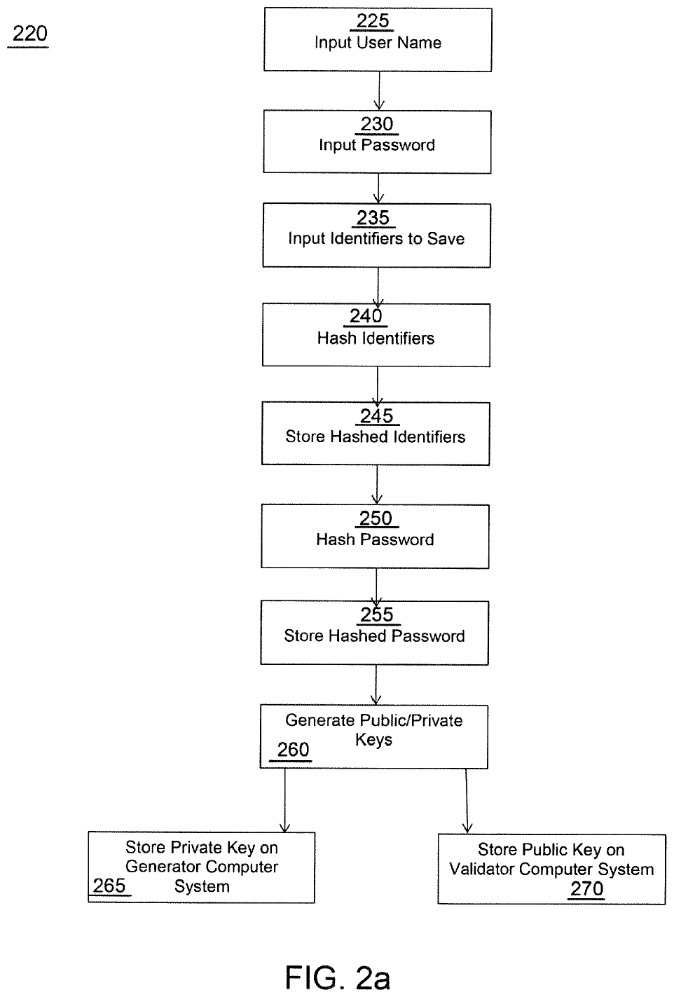

FIG. 2 depicts a system for enrollment of users in the Authorization Token system. In an embodiment, the enrollment system includes the generator (105) and the validator (120) shown in FIG. 1 and described herein. The generator may include one or more hashers (203, 205) for hashing a data string (i.e., transforming the string of characters into a shorter or different string). The generator may also include a PKI Generator (201) for generating public and private keys as part of the Public Key Infrastructure (PKI) system. The generator may also include a data storage device (204) which stores identifiers, hashed identifiers, and private keys generated by the PKI Generator (201). As will be understood, the generator may comprise a computer device which also includes a display, a computer processor, and a communications device, as well as memory for storing the software or application for implementing the user enrollment function and the Authorization Token generation function. The communications device may be used to transmit the public key to the validator (120), which may store the public key in a data storage device (202). In an embodiment in which the validator comprises a validator computer system, the system may also include memory, computer instructions for implementing the validation function, a communications device for communicating with the generator and transaction process computer systems, a computer processor for processing the computer instructions, a display or interface, and a keypad for receiving an identifier (207) and a password (209). In an embodiment, the validator computer system may comprise the same computer system on which the generator resides.

FIG. 2a depicts an exemplary process (220) for a user to enroll in the Authorization Token system, so that the user may generate Authorization Tokens in association with the use of identifiers. In FIG. 2a, a user enrolls in the system by providing at blocks (225 and 230) sufficient establishment of his/her identity, through any one of a variety of methods, and then creating a username and inputting a password which will be used to access the generator (105). The user password may be entered into a keypad (if the password is a character-string) or may be provided indirectly in response to a user interacting with a biometric device such as a fingerprint or facial recognition scanner. The user will use the password to access the generator in the future, to generate Authorization Tokens for transactions. At block (235), the user may input the identifier or identifiers that the user wishes to use with the Authorization Token system, such as account numbers and credit card numbers. These identifiers are stored at block (245) in the generator (105), in a local data storage device such as repository (204). In some embodiments, the identifiers may be cryptographically hashed before storing, at block (240). At block (250), a one-way cryptographic hash of the password received in block (230) (“Password Hash”) is created utilizing hasher (203) and also stored at block 255 in local data repository (204), which can be used to test at future logins.

Additionally, at block (260) the password is used by PKI Generator (201) to create a pair of Public and Private Keys, as used in a Private Key Infrastructure (“PKI”) system. The Private Key is stored locally in the local data repository (204). In an embodiment, the Public Key is stored, along with the Identifier(s) or more commonly hashed values derived from the identifier(s) by hash generator (205) and optionally the hashed password generated at block (250), in a record on a remote database or file (202) that is located on the validator (120) for centralized/remote access. Remote database (202) may be referred to as a user or public key database. While it is possible to store a different (potentially hashed) identifier, or no identifier on validator (120), in some embodiments, one or more hashed identifiers supplied by the user are stored on validator (120). Should validator (120) be compromised through hacking or other means it does not contain useful information such as passwords, private keys or currently valid Authorization Tokens. As noted, in an embodiment, the validator may comprise a software application or module that co-resides with the generator application or module on a computing device.

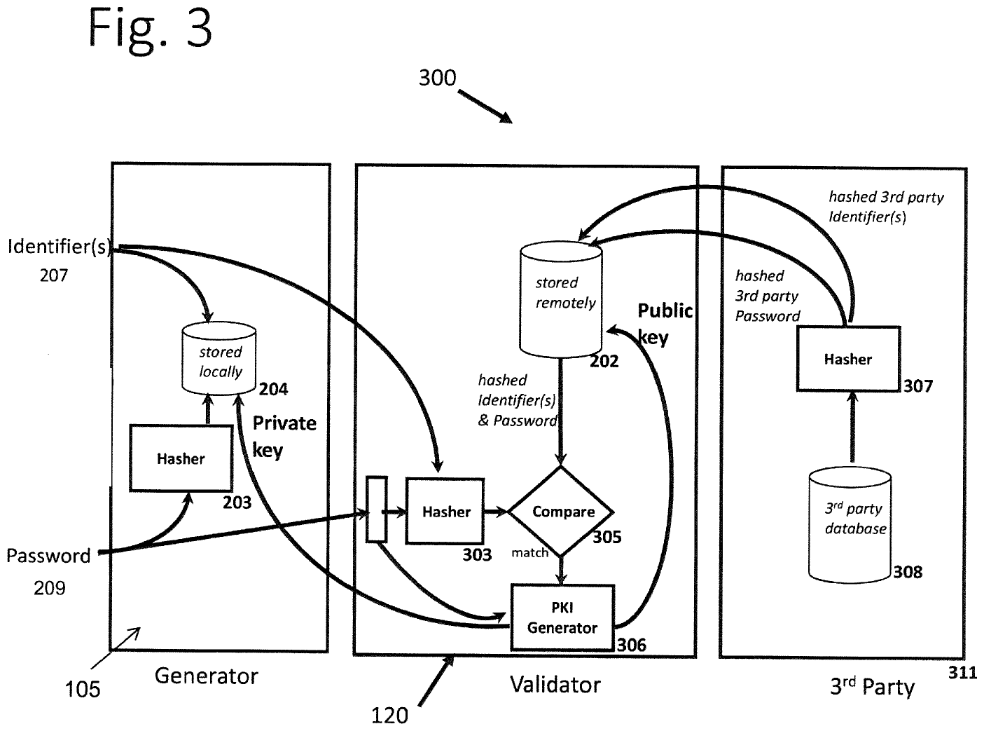

An alternative system (300) to enroll users is depicted in FIG. 3, in which one or more users with credentials stored in a remote third-party computer system (311) can be “bulk enrolled.” In a non-limiting example, the remote third-party computer system (311) may be a bank account system and may include identifiers, passwords, and/or PIN numbers for a plurality of account holders. In a process which is implemented using the system (300), the user Identifier(s) and password(s) may exist in a data storage device remote database or file (308) of the third-party system. The third-party identifiers and passwords may be one-way hashed using a cryptographic function by hasher (307) and loaded into the data repository (202) located in validator (120). In some preferred embodiments, the validator (120) is located on a separate computer system from the third-party computer system (311). When a user first accesses the generator (105), the user may input a password and Identifier that matches those stored at the third-party computer system (311). In some embodiments, the password is first directed towards hasher (203) to generate a hashed version of the password and an (optionally hashed) version of the identifier is stored local data repository (204) in generator computer system (105) for future use. Unlike the enrollment process depicted in FIG. 2, in the enrollment process of FIG. 3 an unhashed copy of the password is temporarily sent to validator (120). In other embodiments, the unhashed copy of the password remains on the generator (105) and the PKI generator (306, or 201 in FIG. 2) and hasher (303, or 203 in FIG. 2) can be located on the generator (105) so that the unhashed copy of the password and the private key need not be transmitted over a network or other communication mechanism as is shown in FIG. 2.

In a process using the system of FIG. 3, validator (120) hashes the password received from the generator (105) with hasher (303) and uses the hashed password to find one or more matching hashed password records from third-party systems (311) in a file or database (202) of the validator. In an embodiment, the Identifier, which may be hashed, is also transmitted from generator (105) to validator (120) and used to further confirm the matched record, thereby substantially reducing the possibility of multiple records matching due to “hash collisions,” i.e., two or more different input data strings resulting in a same hashed data string. When a record is matched, validator (120) uses a Public Key Infrastructure (“PKI”) Generator (306) to create a Public-Private Key pair in part from the unhashed password received from generator (105), associates and stores (202) the Public Key with the identifier, and transmits the Private Key to generator (105) to be stored locally (204). As described previously, in an embodiment where the PKI generator (306) and hasher (303) reside on the generator (105), the private key is locally generated and stored, and the public key is transmitted to the validator (120) to be stored remotely (202). In an embodiment, validator (120) nor the generator (105) retains the Private Key or unhashed password, and may optionally purge the third-party computer system provided hashed version of the password. This process allows users to simply enter an identifier and password used at a third-party computer system, and be enrolled in the system without the third-party sharing unhashed versions of identifiers or passwords.

FIG. 4 depicts a process for generating an Authorization Token using the generator. When the user wishes to authorize use of an identifier (e.g., a credit card number, SSN or an account number) for a transaction, the user generates an Authorization Token through the steps shown in FIG. 4. The user may log into the generator (e.g., directly with a password, indirectly via a password store, through the use of a biometric device, or via another means) to local authentication system (401) for providing access to the generator. Once the authentication system (401) of the generator validates (402) the user's authorization to access the generator, in an embodiment the generator may provide the user with selectable options of account identifiers that the user may authorize (404), and may also provide the user with selectable constraints or limitations that are to be attached to the authorization (405). In embodiments, the user may select from the selectable options of identifiers at least one identifier (at least one selected identifier) that the user wishes to authorize, while in other embodiments the user may simply input the identifier that the user wishes to authorize, rather than selecting the identifier from selectable options. In embodiments, the system may be configured to create a derivative of the identifier, such as by hashing the identifier, as shown in block (406), or by another process, such as applying a mapping process or formula to the identifier to obtain a derivative of the identifier. Some user-initiated or user-selected constraints may include, but are not limited to, for example, the upper threshold constraint of the amount of a transaction (e.g., a maximum value expressed in a maximum dollar value or another currency value), duration of the authorization (e.g. a time limit in minutes, hours, days, or weeks for the duration of authorization constraint), whether the authorized use is for one-time only or multiple times during that period, a maximum number of transactions constraint which may limit the number of transactions which may be performed using the token, the geographic area or physical locale in which authorization is permitted (e.g., the location in which an account is held, the location in which a purchase is authorized, the location in which the transaction may be processed, or the physical location to which access is permitted), an industry constraint indicating an industry in which the identifier may be used, indicated by way of example by a SIC or other code, or a company or entity either within an industry, or without reference to an industry (such as Walmart, or amazon.com) permitted to use the identifier (e.g., a company constraint indicative of a company or entity for which authorization is permitted), a type of transaction constraint which specifies the type or types of activity being authorized (e.g., access to an account, sharing data, moving money out of an account, filing an insurance claim, filing documents with a governmental authority, trading stocks, establishing new credit, or using existing credit), a specific transaction constraint which limits use to a specific transaction which may be defined in the constraint by a transaction identifier, a third-party identity constraint; an account with which the transaction may be processed; an entity, system, or computer program, process, or account identifier authorized to access or transact with; an indicator of the data or types of data to which access is permitted; a physical device constraint identifying a physical device for which authorization is permitted, and other parameters associated with the transaction not listed above.

In an embodiment, the generator computer system may be configured to allow the user to select default or preset values or ranges for any or all of the user-initiated constraints, individually or as a group. For example, the duration can be stored as a default “relative time” value, so that Authorization Tokens by default expire a fixed amount of time (e.g., 15 minutes) from when each one is issued. In an embodiment, this value may be converted into an absolute time value, the “use-by time”, such as the number of seconds or minutes since a fixed reference date and time when each Authorization Token is generated. By way of further example, a user may wish to have a default value for a specific identifier, such as a brokerage account number, with the default purpose of authorizing stock trades. The user may set a combination of default constraints to easily generate Authorization Tokens which only authorize trading stocks in one trading account and which expire 15 minutes after generation. In an embodiment, the generator may also allow the user to select many different kinds of constraints, including but not limited to: Companion Transmitted Information, one or more pre-selected default constraints; a type of data constraint indicative of the type of data for which authorization is permitted.

Generator (105) may include stored program code that causes a processor to execute an algorithm (407) that combines and effectively links the selected Identifier or identifiers if a constraint includes an identifier of an entity or system being authorized (or a hashed version of said Identifier(s) that was processed by hasher (406)) with any user-selected constraints to generate an Authorization Token that is then digitally signed or encrypted with the private key by encrypt function (408), retrieving said key from local storage (204). As noted, the private key is created during user enrollment as shown in FIGS. 2 and 3. The combining of the identifier with the user-selected constraints in the Authorization Token is used to ensure that the identifier is being validly used along with the user-selected constraints. The identifier and user-selected constraints are considered combined (or linked) in that both are part of the Authorization Token that is generated to permit the transaction. The Authorization Token may be displayed (410) to the user.

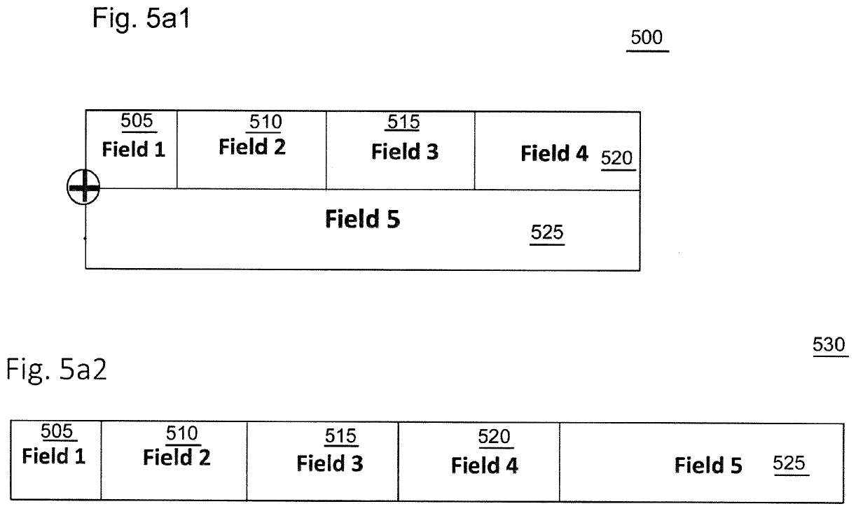

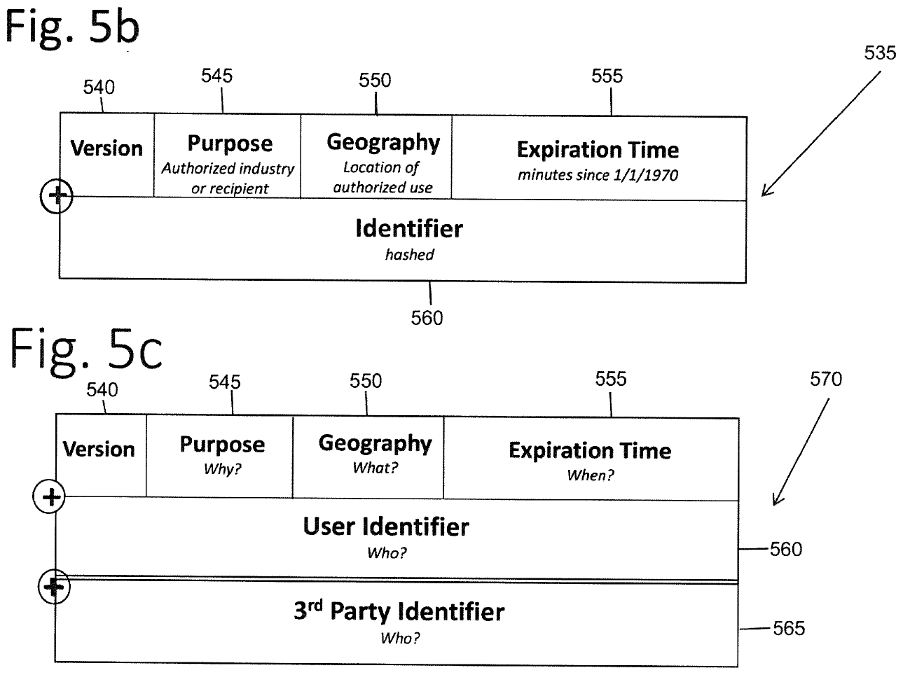

For ease of use, and to reduce data storage and transmission requirements associated with the Authorization Token, it may be desired to limit the size of the Authorization Token. FIG. 5a1 demonstrates one exemplary data structure (500) used to combine constraints and/or Identifiers that keep the Authorization Token small by creating distinct fields (505, 510, 515, 520, and 525) and optionally mathematically manipulating them in ways that can be reversed to yield the distinct, original values. FIG. 5a2 depicts a data structure (530) in which individual fields (505, 510, 515, 520, and 525) are created to hold the values of the Identifier(s) and constraints, but the presence of multiple concatenated fields tends to lengthen the Authorization Token. In an embodiment, the step of combining may comprise first concatenating the user-selected constraints to generate concatenated user-selected constraints, and to that applying one of a summation function or an exclusive-or function, to any number of identifiers, or potentially hashed or otherwise derivative values of the identifiers, or other user-provided data.

The signed or encrypted Authorization Token may be transmitted along with one or more other pieces of information (“Companion Transmitted Information”), such as the (potentially hashed) Identifier(s) and optionally the values of one or more constraints. The mathematical representation or hashed versions of the Companion Transmitted Information values can be reversibly combined, or linked, with the concatenated fields of the Authorization Token using summation or an “Exclusive-Or” function (“XOR”) as shown in FIG. 5a1 to create the Authorization Token in software algorithm (407). In other embodiments, the fields may be combined (or linked) with the other fields of the Authorization Token using any reversible mathematical function that when reversed, reveals the original contents of the fields. Some non-limiting examples of other reversible mathematical functions include an n-variable vectorial Boolean or a Fourier transform function. As depicted in FIG. 5a1, the Companion Transmitted Information to later be mathematically removed from an unencrypted Authorization Token, by, in the summation or XOR example, subtracting their numerical representation(s) or repeating the XOR function. The result of this is a shorter Authorization Token that still contains all the desired information, which reduces the data required to enter or store Authorization Tokens, and reduces the transmission requirements associated with the Authorization Tokens. This approach is particularly useful when the system is configured to receive Companion Transmitted Information to the transaction processor as a separate data input from the Authorization Token, which permits the Authorization Token to be used to validate the values of the Companion Transmitted Information.

FIG. 5b provides one example of an Authorization Token data structure (535). In this example, prior to encryption, the user selects constraint values that indicate the Industry of intended use (“Purpose”) (545), location (“Geography”) (550), and duration of authorized use (“Expiration Time”) (555) of an Identifier (560). These are placed in concatenated fields, along with a version number (540) to indicate the order and meaning of the fields. The Identifier (560) is hashed to create a fixed length, and the value of the hashed Identifier is added to the value of the concatenated fields. Once this Authorization Token is encrypted, it can be transmitted separately from the hashed or unhashed value of the identifier to a validator. The validator can decrypt the Authorization Token, subtract the value of the hashed Identifier, and retrieve the distinct values for Purpose, Geography, and Expiration Time with high confidence that they were not falsified and that they relate to the supplied Identifier.

FIG. 5c provides an example of the data structure (570) of an Authorization Token in which two sets of Companion Transmitted Information have been added to the version (540) and user-selected constraint fields (545, 550, and 555), prior to encryption. In this example, a consumer may be providing authorization for a trusted third-party to access an account or information about that consumer at the transaction processor. In this example, the Companion Transmitted Information includes two distinct values; the User Identifier (such as an account number) (560) as well as an Identifier of the third-party being authorized (such as an accountant) (565). By subtracting both Companion Transmitted Information identifiers from the decrypted Authorization Token, the remaining constraints are revealed for validation.

The constraints in this example might include values such as the “Data Type(s)” that may be accessed (such as read-only access to profits and losses). As before, the location of residence of the account holder or third-party could be indicated by “Geography” and the “Expiration Time” limits the duration of access. In such an example, the user may give an Authorization Token to an accountant that can be presented by the accountant to the user's financial institution, allowing the accountant to directly access a subset of the account information. In other examples, users may permit third-party information aggregators to collect only current values of accounts, or permit only relevant medical records to be shared with a healthcare professional

For simplicity, the Authorization Token may be encrypted through the use of Format Preserving Encryption (“FPE”) or similar mechanisms that limit the output to characters that are easily human readable. Note that in many cases, the encryption generates an Authorization Token at least as long as the unencrypted Authorization Token (unless truncated). Note further that the individual values of constraints and Identifiers are either sent as part of the Companion Transmitted Information and/or can be recovered directly from the Authorization Token. This is so that the system verifying Authorization Tokens need not store information about tokens which have been issued and are available. Rather, the Authorization Tokens contain the necessary information which has been cryptographically protected against modification or misuse. As noted, centralized stores of valid tokens, as commonly seen with one-time SMS or email authorization codes, are vulnerable to compromise through hacking or other means, allowing access to potentially usable tokens. Additionally, the transmission of tokens from a centralized store to a user is subject to interception and/or redirection.

Once generated mathematically, either locally on a device or centrally, the Authorization Token may be returned and displayed to the user (410) as depicted in FIG. 4. This display can be in the form of a human readable string of characters (in embodiments, a character string), or presented through a machine readable mechanism such as a “bar code” or a QR code or some other picture or arrangement of symbols or characters that is unique and can provide/encode the necessary information.

FIG. 6 depicts an exemplary Authorization Token validation process (600). When a party represented as a transaction processor (115) wishes to make use of an Identifier, it performs a validation process (600) as depicted in FIG. 6. This is done by the transaction processor (115) collecting the Authorization Token and at least one Identifier from a user (601), who, in one embodiment, utilizes a user device (615), such as a mobile phone or smart phone. This information is then transmitted, in one embodiment from the transaction processor (115), to a central validator (120) that uses the identifier to fetch the associated public key from the database (202), deconstructs and tests the validity of the Authorization Token (including determining whether the user-constraints have been met, i.e., satisfaction of the user-selected constraints), and returns a response based on the validation test. Central validator (210) may access database (610) to obtain data, such as that needed to test constraints. Responsive to confirmation of the validity of the Authorization Token, the central validator (120) generates and transmits to the transaction processor (115) a message indicating the validity of the Authorization Token to permit execution of the transaction.

FIG. 7 depicts an embodiment of the Authorization Token validity test process performed by the validator (120). In this example, an Authorization Token and unhashed value of an Identifier (in embodiments, at least one identifier)are provided to a central/remote validator (120) which comprises a computer system, via an Application Programming Interface or “API” (701). The Identifier has applied a hashing module (702) to generate a hashed Identifier, and the hashed Identifier is compared (704) with a plurality of hashed Identifiers in the validator computer systems data storage device files or database (202). When a match is found, the Public Key corresponding to the stored matching Identifier hash is identified (i.e., the identified public key) and is used to decrypt (705) the Authorization Token. The contents of the Authorization Token are then deconstructed by reversing the methods used to combine or link them, as previously described and shown in FIGS. 5a1 and 5b. Continuing with FIG. 7, at block (706), the hashed Identifier is separated from the user-selected constraints. The constraints may be tested (707) to determine if they have been satisfied (i.e., the transaction complies with all the related constraints). Some values to test constraints, for example the industry (industry constraint) or geography (geographic area constraint) for which authorization is being requested, can also be retrieved from the validator's storage device (202) and associated with the specific transaction processor (115) requesting validation. If an Expiration time is used as a constraint, for example, it can be tested to ensure that it is in the future, and can be optionally tested to make sure it is in the near future (e.g. not more than 30 days, should the system impose an upper limit re how long an Authorization Token is valid). If the system implements an option for one-time use of Authorization Tokens, it can store (202) the Authorization Token to prevent reuse before it expires (and an additional test (707) added to ensure that valid but used Authorization Tokens are not reused). Should not all constraints be met, the system checks (708) for additional matches of the hashed identifier in the validator computer system's files or database (202). If no matching hashed Identifier is found, or none are found with all tested constraints met, a message indicating that the Authorization Token was determined to be not valid is returned via the API. Should a matching hashed Identifier be found with all tested constraints met, a message indicating that the Authorization Token provided was determined to be valid is returned.

In some embodiments, a constraint may include physical or logical attributes of the device generating the Authorization Token, such as a device ID, which can be sent as an additional identifier or constraint and stored at the validator upon enrollment, to add an additional “factor” as part of a “multi-factor authentication system.” This allows the Authorization Token to be bound to a specific generating device or devices, such as, but not limited to, specific user mobile devices. The fact that the private key resides solely on the device generating the Authorization Token further treats the devices as a “factor” (i.e., “something you have”).

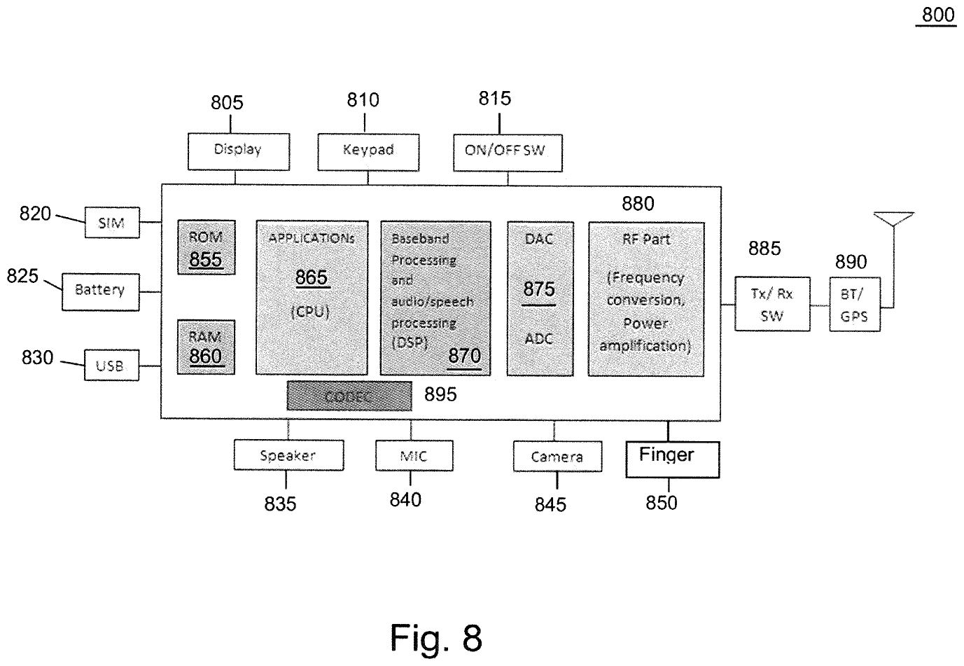

FIG. 8 depicts a block diagram of a mobile device (800) which may implement the generator for generating Authorization Tokens, in accordance with an aspect of the disclosure. The mobile device includes display (805), keypad (810) (which may be a physical or virtual keyboard), and on/off switch (815). The mobile device may also include SIM card slot (820), battery (825), USB (Universal Serial Bus) port (830), CODEC (895), speaker (835), microphone (840), camera (845), and fingerprint reader or sensor (850). The mobile device may further include read-only-memory (ROM) (855), random-access memory (RAM) (860), central processor and applications (865), and baseband processing (870). Further, mobile device may include digital to analog converter (DAC) and analog to digital converter (ADC) (875), RF part (Frequency Conversion and Power Amplification) (880), transceiver/receiver (885), and Bluetooth and GPS (890).

As noted, in some embodiments the Authorization Token generator (element (105) in FIG. 1) is resident on a self-contained device such as a mobile device or other user device, which unconventionally permits Authorization Tokens to be generated by a consumer without the mobile device connectivity with a server-based system under the control of a third-party or an external server. This arrangement provides for increased security over prior art systems as it prevents attempts to intercept and/or redirect tokens generated by centralized token generation systems, and prevents attempts to access tokens stored in a centralized database. In an addition to the above, the Authorization Tokens of the current disclosure are unconventional in that they contain information selected by the user that provide constraints on the transaction as opposed to pins generated and used by current systems.

The central processor and application (865) may store an Authorization Token generation application for providing access to the application, receiving a selection of an identifier and user-selected constraints for inclusion in the token, linking or combining the constraints and at least one identifier (which may be hashed), and then encrypting the combination with a private key and displaying the outputting the token. The combining may be performed using any reversible mathematical function (in embodiments, a reversible mathematical transformation function) that when reversed, reveals the original contents of the fields. For example, a summation, exclusive-or, an n-variable vectorial Boolean or a Fourier transform function can be used. Access to the application (local authentication) may be made by directly providing a username by the keypad (810) and a password by the keypad, or indirectly by unlocking a keychain on the device using a camera (845) for a facial recognition, or by fingerprint sensor (850) for a fingerprint. The application (865) is configured to cause the processor to effect the generation of the Authorization Token, in accordance with the process shown in FIG. 4, including the hashing, combination/linking, and encryption steps. The Authorization Token may be output on the display (805).

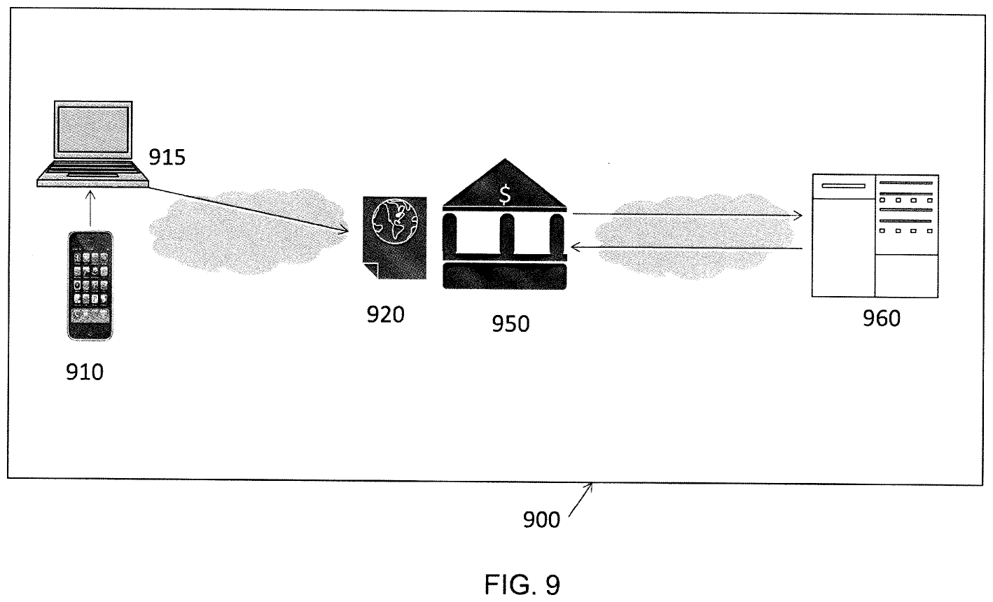

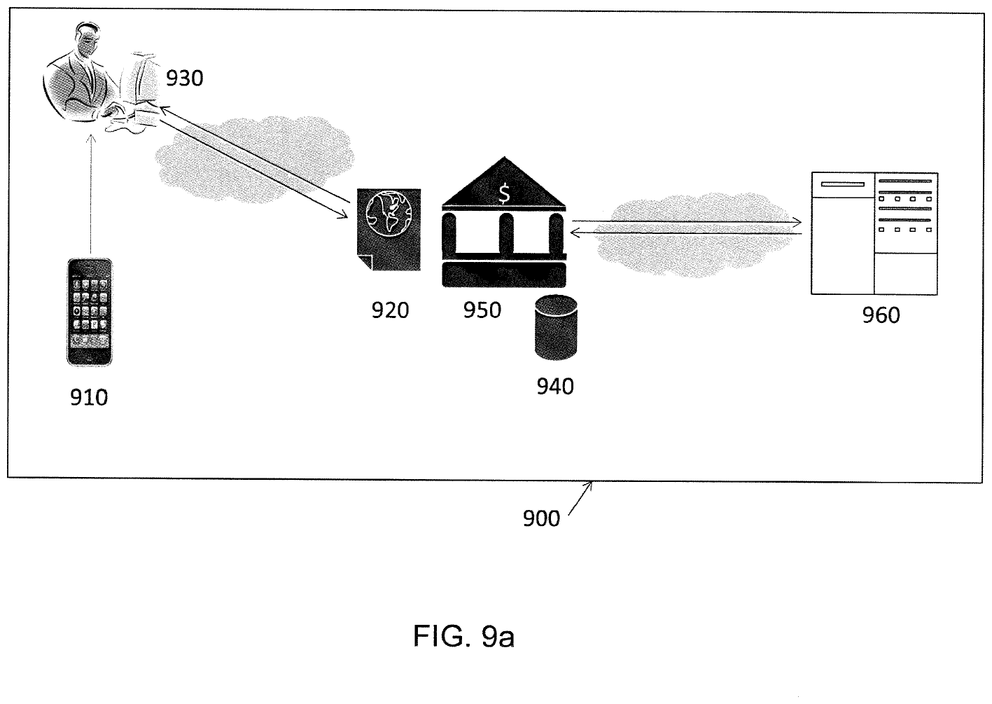

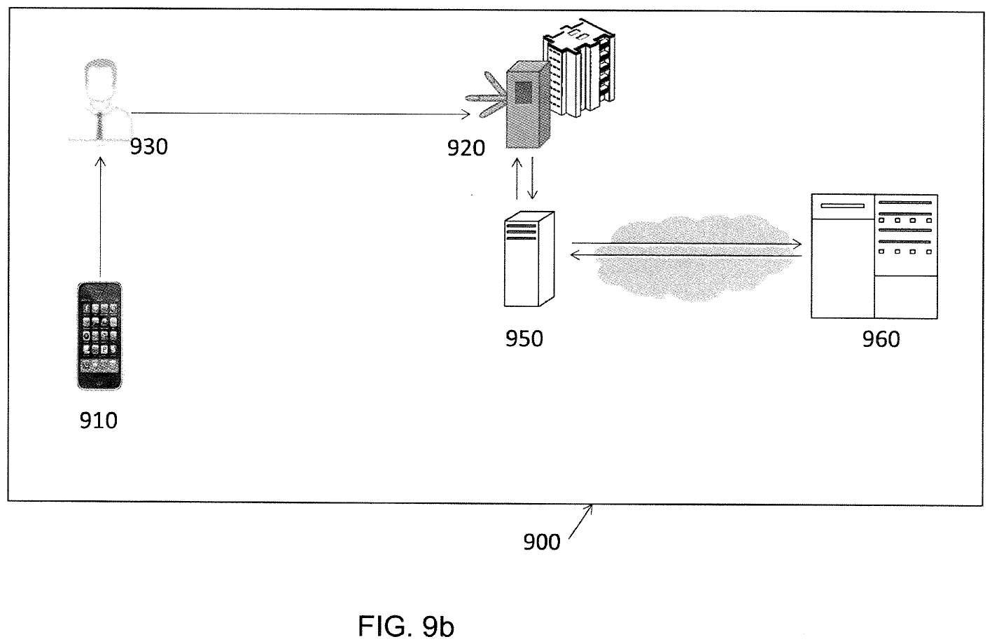

FIG. 9 depicts a high-level system block diagram (900) of merely one embodiment of the disclosure which includes exemplary devices and relationships between devices which perform the functional elements of FIG. 1 for an embodiment of the disclosure. FIG. 9 is not dispositive of all the architectural configurations and relationships that are deployable in view of the disclosures defined herein. The intent of FIG. 9 is to define one set of hardware elements inter-operatively connected to provide one environment of the deployment of the underlying technology defined herein. In the embodiment shown in FIG. 9, the Authorization Token generator (105 in FIG. 1) may be resident on user device (910). In an embodiment, the user device (910) may comprise a mobile device such as a tablet, smart phone, or smart watch, and the generator comprises an application that is executed (or running) on the device. In an alternative embodiment, the user device comprises a laptop or desktop computing device, and the generator comprises a software application that is being executed on the device. The user device may include memory storing program instructions or applications, a processor for executing the software or applications, and a display for outputting the Authorization Token. Specifically, the embodiment and application defined by FIG. 9 includes a financial institution (950), the institution's web server (920) which may act as the transaction capture system (110) of FIG. 1, and a user's computer (915) which connects to the web server.

The generator function (105) from FIG. 1 runs on the user's mobile device (910) and creates an Authorization Token to be entered into a field rendered by the web browser of the user's computer (915). Validation of this Authorization Token provides the necessary authentication and authorization for the institution (950) to proceed. The institution (950) may comprise an entity or an entity computer system. In an embodiment in which the institution comprises the entity computer system, the entity computer system may comprise the same system as the web server (920), may comprise a system on an enterprise computer system that includes the web server (920), or may comprise a system which is separate from the web server (920).

The web server (920) at the institution acts as the transaction capture system (110) in FIG. 1, creating a means by which the institution (950) gathers the user's identifier, instructions, which in previous embodiments are described as user-selected constraints, and an Authorization Token. The institution (950) acts as the transaction processor (115) in FIG. 1 and queries a remote validation computer (960) to ensure that the transaction request is permitted for the user's account identifier by the Authorization Token. The remote validation computer (960) serves the role of the validator (120) in FIG. 1.

FIG. 9a provides another application that is a slight variant and fully within the scope of the defined disclosure of the embodiment of FIG. 9, in which a trusted third-party (930) requires access to data stored (940) at the institution (950). In an exemplary case, the third-party (930) could be an accountant who requires tax information from a bank. In other cases, the third-party could be an aggregation service that consolidates financial information from multiple institutions or an entity who can perform periodic checks of a credit score from a credit bureau. In each case, the institution (or institution computer systems) permits a third-party (930) to access a limited set of information associated with a user's account (940), subject to request validation.

In FIG. 9a, the user's mobile device (910) generates the Authorization Token which is shared with the trusted third-party (930). Subsequently, the third-party can provide the Authorization Token, the account identifier, and a request for information associated with the account to an Application Programming Interface (“API”) or web server (920) system at the institution (950). The institution (950) validates the request using the account identifier, trusted third-party identifier, and type of data being requested against the supplied Authorization Token by querying the remote validation computer (960). In this example, the trusted third-party identifier in the Authorization Token is compared with the authenticated identity of the third-party requesting access, and the account identifier is compared with the requested user's account identifier holding the data.

FIG. 9b provides a similar yet distinct example of trusted third-party authorization. In this case, the owner or occupant of a physical building desires to provide limited access to the facility.

The owner or occupant's mobile device (910) serves as a generator (105) in FIG. 1 and creates an Authorization Token for the trusted third-party (930) to access a specific building or floor of a building.

The trusted third-party (930) presents this Authorization Token at a building entry point or turnstile (920), which may capture the token by scanning a bar code or other means. In receiving the Authorization Token, the turnstile acts as a transaction capture system (110) from FIG. 1. The turnstile (920), or a computer system connected to it (950) then acts as the transaction processor (115) in FIG. 1 by presenting the building and entry point data to the remote validation computer (960) which serves the role of the validator function (120) in FIG. 1.

Should the remote validation computer (960) determine that the access constraints and identifiers (such as a trusted third-party identifier, the identifier of the owner or occupant of the building, the specific building or entry point (or the geography of the building or entry point), and the time have all been successfully met, it indicates acceptance to the computer system (950) connected to or integrated with the turnstile (920) to grant access.

### Examples of Use

The following examples are provided as helpful, but not limiting illustrations, of some commercial deployments of the present disclosure.

This system can be applied when a consumer or entity wishes to perform a transaction to establish a new account, change an existing account, transact business associated with an account, or delegate authorization to another party.

The use of an identifier such as a SSN (Social Security Number), EIN (Employer Identifier Number), or account number is a well understood mechanism for self-identification. For example, opening a new credit card account requires providing a financial institution with a SSN. Today, the institution may seek to validate the identity of the person opening the account, but is unable to generally determine if the use of the identifier has been authorized (or if the identity is being misused to fraudulently open an account).

Using the embodiments of the disclosure, the consumer indicates that they expect a transaction to occur in the near future and provides evidence through the generation of an Authorization Token. The code can be quickly and easily generated by the consumer on his/her mobile phone and is provided along with the SSN (the Identifier) to the financial institution. The financial institution can quickly and easily call an Internet service (i.e., a validator computer system or a validator software application) to validate the Authorization Token. Similarly, when a consumer interacts with the institution to make account changes, the consumer can provide the institution's account number or the consumer's SSN with the Authorization Token to verify that the change was expected.

A similar mechanism can be employed when a consumer wishes to transact business, such as making an electronic purchase. For example, a limitation of a credit or debit card today exists in that the card number (the Identifier) and even a debit card “PIN” are static and subject to misuse. Replacing a static PIN would allow a consumer to generate a one-time code that could be used in-store (perhaps by scanning a bar code displayed on a mobile phone which represents the Authorization Token) or online (entering a string of characters which represents the Authorization Token along with the credit or debit card number). This could dramatically reduce fraudulent transactions.

The use of a generated Authorization Token can be used in a number of ways, including but not limited to:
(i) withdrawing funds from an account at a financial institution by providing explicit, constrained authorization, thereby reducing or eliminating the need for behavioral activity based fraud detection;
(ii) generating authorization to debit an account to use a service, such as entering a public transportation system, without the need for the consumer to have a dedicated card or device and without needing internet access;
(iii) providing authorization for a governmental authority, such as a revenue or tax authority, to use a governmental-issued identifier, such as a tax identifier, to process documents submitted to the governmental authority, such as a tax return, thereby reducing fraudulent filings;
(iv) providing a medical or other provider with authorization to file an insurance claim using an insurance account number or social security number as the Identifier, thereby reducing insurance fraud;
(v) providing a stock broker with authorization to execute a trade, thereby reducing or eliminating account takeover fraud;
(vi) authorizing the limited sharing of information held by an institution with a trusted third-party, wherein the selected identifier comprises an account number for the account;
(vii) debiting an account balance to permit a transaction, wherein the selected identifier comprises a debit account number not maintained by a financial institution; and
(viii) authorizing one of use or access to a physical or virtual asset, such as access to an account on a computer system or computer network, to a building or access and operation of a vehicle.

As listed above, the Authorization Token may be used to delegate authorization to third-parties or users. In such an embodiment, the generator can be configured so that a user can select the identifier to be used, the user-constraints, and a third-party that is authorized to use the Authorization Token. Then, after local authentication, the generator may output the Authorization Token to allow the third-party limited access to data in an account. In an embodiment, the system can be configured to provide the Authorization Token directly to the third-party (such as by email), while in another embodiment the Authorization Token may be issued to the user, who is then responsible to share the authorization with the third-party (e.g., by the user sharing the string of characters that represents the Authorization Token), and then the Authorization Token can be presented by the third-party to an entity holding account information with the assertion that the third-party has been permitted access. The holder of the account information can validate the Authorization Token for the account identified, along with any restriction regarding the third-party, the time, the location, or the type of information being requested. Examples of this include, but are not limited to:
(i) providing limited authorization for an account aggregator to view current balances in a financial services account, without sharing login credentials and without providing access to other information such as demographics
(ii) providing limited authorization for a tax preparer to view profits and losses in a financial services account, also without sharing login credentials or providing access to other information
(iii) providing limited access to or authorization for a third-party to use an application, system, building, or vehicle
   Key to these examples is the understanding that, without this system, static identifiers and PINs retain their value over time, and can be misused and reused. The use of a changing token with embedded constraints adds a layer of authorization that is currently missing in the systems in place today.

Authorization Tokens can also include or embed within them other information restricting their use. For example, the user-selected constraints associated with the token may limit individual or aggregate transaction sizes, or may limit the location in which they were generated or are authorized for use (e.g. GPS coordinates, looking up the approximate location of a device's assigned IP address, etc.). This information can be optionally used to further restrict to use of an Authorization Token or tokens to a physical area. In the location-restricted example, should a user wish to generate one or more tokens to authorize credit card transactions while shopping in a store, the physical location of the merchant can also be tested and validated as a part of the process. Location could be further expanded to include a shopping center or a larger geography to authorize in-person or online transactions.

The computer systems, computing devices, and mobile devices disclosed herein may be in the form of a stand-alone computer, a desktop computer, a laptop computer, a mobile smart phone, a tablet, a distributed computing system, a centralized computing system, a network server with communication modules and other processors, or nearly any other automated information processing system configured to receive and analyze data from other computer systems. The storage devices disclosed herein may comprise any form of data storage device including but not limited to electronic, magnetic, optical recording mechanisms, combinations thereof or any other form of memory device capable of storing data.

Each or any combination of the blocks and components shown in the Figures may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to the Figures, these modules may perform functionality described later herein.

The flow charts described herein do not imply a fixed order to the steps, and embodiments of the present disclosure may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

1. A system for electronically authorizing a transaction, the system comprising:
a user computing device including an Authorization Token generator application configured to:
authenticate access of a user to the Authorization Token generator application;
receive at least one identifier to authorize for the transaction;
receive at least one user-selected constraint for limiting use of the at least one identifier;
combine the at least one identifier and the at least one user-selected constraint to create a unique token;
encrypt the unique token using a stored private key to generate an Authorization Token; and
provide the Authorization Token for validation to a transaction processor computer system without requiring prior recording of any information regarding the creation of the Authorization Token external to the user computing device; and
a validator computer system to validate the transaction.

2. The system of claim 1, wherein the validator computer system is configured to:
receive, from the transaction processor computer system, the Authorization Token;
test a validity of the Authorization Token; and
responsive to a confirmation of the validity of the Authorization Token, generate and transmit to the transaction processor computer system a message indicating the validity of the Authorization Token to permit execution of the transaction.

3. The system of claim 2, wherein the validator computer system is configured to:
compare at least one hashed identifier to a plurality of hashed identifiers stored in a database which stores matched hashed identifier and public key pairs;
identify a public key which corresponds to the at least one hashed identifier;
decrypt the Authorization Token based on the identified public key;
separate the at least one hashed identifier from the at least one user-selected constraint in the decrypted Authorization Token;
determine whether the at least one user-selected constraint is satisfied; and
responsive to a satisfaction of the at least one user-selected constraint, generate and transmit to the transaction processor computer system a message indicating the validity of the Authorization Token to permit execution of the transaction using the at least one identifier.

4. The system of claim 1, wherein the at least one user-selected constraint include at least one of:
(i) an upper threshold constraint indicative of a maximum dollar value for which authorization is permitted;
(ii) a duration of authorization constraint indicative of a time limit during which authorization is permitted;
(iii) a number of transactions constraint indicative of a number of transactions for which authorization is permitted;
(iv) a geographic area constraint indicative of a geographic area of a merchant or service provider in which authorization is permitted;
(v) an industry constraint indicative of an industry for which authorization is permitted;
(vi) a company constraint indicative of a company or entity for which authorization is permitted;
(vii) a type of transaction constraint indicative of a type of transaction for which authorization is permitted;
(viii) a specific transaction constraint indicative of a specific transaction for which authorization is permitted;
(ix) a physical device constraint identifying a physical device for which authorization is permitted;
(x) a third-party identity constraint identifying a third-party for whom authorization is permitted;
(xi) one or more pre-selected default constraints;
(xii) a type of data constraint indicative of at least one type of data for which authorization is permitted; and
(xiii) a type of access constraint indicative of a type of access for which authorization is permitted.

5. The system of claim 1, wherein the Authorization Token generator application is configured to create the unique token including at least one of (i) the at least one identifier and (ii) a derivative of the at least one identifier and (iii) the at least one user-selected constraint in a field of the unique token.

6. The system of claim 5, wherein the Authorization Token generator application is configured to combine
by applying a reversible mathematical transformation function to at least one of (i) the at least one identifier and (ii) the derivative of the at least one identifier and (iii) the at least one user-selected constraint.

7. The system of claim 6, wherein the reversible mathematical transformation function comprises one of a summation function or an exclusive-or function or an n-variable vectorial Boolean or a Fourier transform function.

8. The system of claim 1, wherein the Authorization Token generator application is to provide the Authorization Token by displaying one of a character string representative of the Authorization Token, a bar code representative of the Authorization Token, or a QR code representative of the Authorization Token.

9. A method for generating an Authorization Token on a user computing device for authorizing a transaction, the method comprising:
receiving, by an Authorization Token generator application, at least one identifier to authorize for the transaction;
receiving, by the Authorization Token generator application, user-selected constraints for limiting use of the at least one identifier;
combining, by the Authorization Token generator application, the at least one identifier and the user-selected constraints to create a unique token;
encrypting, by the Authorization Token generator application, the unique token using a private key to locally generate the Authorization Token; and
providing, by the Authorization Token generator application, the Authorization Token to the user computing device without requiring prior recording of any information regarding the creation of the Authorization Token external to the user computing device, wherein the Authorization Token is configured to authorize the execution of the transaction.

10. The method of claim 9, wherein the user computing device is a mobile device and the step of combining the at least one identifier and the user-selected constraints to create the unique token comprises creating the unique token including at least one of (i) the at least one identifier, and (ii) a derivative of the at least one identifier and (iii) the user-selected constraints in a field of the unique token.

11. The method of claim 9, wherein the combining the at least one identifier and the user-selected constraints to create the unique token comprises combining, by applying a reversible mathematical transformation function, at least one of (i) the at least one identifier and (ii) the derivative of the at least one identifier and (iii) the user-selected constraints.

12. The method of claim 11, wherein the reversible mathematical transformation function comprises one of a summation function and an exclusive- or function and an n-variable vectorial Boolean and a Fourier transform function.

13. The method of claim 9, further comprising authenticating and validating, by a validator computer system, the at least one identifier and the Authorization Token, wherein the authenticating and validating comprises:
receiving, by the validator computer system from a transaction processor computer system, the at least one identifier and the Authorization Token transmitted to the transaction processor computer system to authorize the transaction;
testing, by the validator computer system, a validity of the Authorization Token; and
responsive to a passing of the validity test of the Authorization Token, generating and transmitting, by the validator computer system to the transaction processor computer system, a message indicating the validity of the Authorization Token to permit execution of the transaction.

14. The method of claim 9, wherein the user-selected constraints include at least one of:
(i) an upper threshold constraint indicative of a maximum dollar value for which authorization is permitted;
(ii) a duration of authorization constraint indicative of a time limit during which authorization is permitted;
(iii) a number of transactions constraint indicative of a number of transactions for which authorization is permitted;
(iv) a geographic area constraint indicative of a geographic area in which authorization is permitted;
(v) an industry constraint indicative of an industry for which authorization is permitted;
(vi) a company constraint indicative of a company or entity for which authorization is permitted;
(vii) a type of transaction constraint indicative of a type of transaction for which authorization is permitted;
(viii) a specific transaction constraint indicative of a specific transaction for which authorization is permitted;
(ix) a physical device constraint identifying a physical device for which authorization is permitted;
(x) a third-party identity constraint identifying a third-party for whom authorization is permitted;
(xi) one or more pre-selected default constraints;
(xii) a type of data constraint indicative of at least one type of data for which authorization is permitted; and
(xiii) a type of access constraint indicative of a type of access for which authorization is permitted.

15. The method of claim 9, wherein the user-selected constraints include a third-party identity constraint identifying a third-party for whom authorization is permitted;
wherein the transaction comprises providing access; and
wherein validation of the Authorization Token provides the third-party with the access.

16. The method of claim 9, wherein the user-selected constraints include an identifier of a third-party for whom authorization is permitted;
wherein the third-party identifier is transmitted as Companion Transmitted Information with the Authorization Token;
wherein the transaction comprises providing access; and
wherein validation of the Authorization Token provides the third-party with the access.

17. A validator computer system for electronically authorizing a transaction that is configured to:
receive, from a transaction processor computer system, an Authorization Token that is generated by an Authorization Token generator application without requiring prior recording of any information regarding the generation of the Authorization Token external to the Authorization Token generator application;
test a validity of the Authorization Token; and
responsive to a confirmation of the validity of the Authorization Token, generate and transmit to the transaction processor computer system a message indicating the validity of the Authorization Token to permit execution of the transaction.

18. The system of claim 17, wherein the validator computer system is configured to:
compare at least one hashed identifier to a plurality of hashed identifiers stored in a database which stores matched hashed identifier and public key pairs, and identify a public key which corresponds to the at least one hashed identifier;
decrypt the Authorization Token based on the identified public key;
separate at least one identifier from user-selected constraints in the decrypted Authorization Token;
determine whether the user-selected constraints are satisfied; and
responsive to a satisfaction of the user-selected constraints, generate and transmit to the transaction processor computer system a message indicating the validity of the Authorization Token to permit execution of the transaction using the at least one identifier.

19. The system of claim 18, wherein the user-selected constraints include at least one of:
(i) an upper threshold constraint indicative of a maximum dollar value for which authorization is permitted;
(ii) a duration of authorization constraint indicative of a time limit during which authorization is permitted;
(iii) a number of transactions constraint indicative of a number of transactions for which authorization is permitted;
(iv) a geographic area constraint indicative of a geographic area of a merchant or service provider in which authorization is permitted;
(v) an industry constraint indicative of an industry for which authorization is permitted;
(vi) a company constraint indicative of a company or entity for which authorization is permitted;
(vii) a type of transaction constraint indicative of a type of transaction for which authorization is permitted;
(viii) a specific transaction constraint indicative of a specific transaction for which authorization is permitted;
(ix) a physical device constraint identifying a physical device for which authorization is permitted;
(x) a third-party identity constraint identifying a third-party for whom authorization is permitted;
(xi) one or more pre-selected default constraints;
(xii) a type of data constraint indicative of at least one type of data for which authorization is permitted; and
(xiii) a type of access constraint indicative of a type of access for which authorization is permitted.

20. The system of claim 18, wherein the transaction for which the Authorization Token is generated comprises one of:
(i) withdrawing funds from an account at a financial institution, wherein the at least one identifier comprises an account identifier for the account;
(ii) providing a tax authority with authorization to use a tax identifier to process a tax return, wherein the at least one identifier comprises the tax identifier;
(iii) providing a medical provider with authorization to file an insurance claim, wherein the at least one identifier comprises one of an insurance account number or a social security number;
(iv) providing a stock broker with authorization to execute a trade, wherein the at least one identifier comprises an account identifier for a trading account;
(v) a purchase transaction for a good or service, wherein the at least one identifier comprises one of a credit card number or a debit card number used for payment.
(vi) authorizing a limited sharing of information held by an institution with a trusted third-party, wherein the at least one identifier comprises an account number for the account;
(vii) debiting an account balance to permit a transaction, wherein the at least one identifier comprises a debit account number not maintained by a financial institution; and
(viii) authorizing one of use and access to one of a physical asset and a virtual asset and an account.
